(19) United States
(12) Patent Application Publication
(10) Pub. No.: US 2003/0193464 A1
(43) Pub. Date: Oct. 16, 2003

(54) Method for driving liquid crystal display panel and liquid crystal display device

(76) Inventors: Atsuhiro Yamano, Hyogo (JP); Hiroshi Takahara, Osaka (JP); Hitoshi Tsuge, Osaka (JP)

Correspondence Address: GREENBLUM & BERNSTEIN, P.L.C., 1950 ROLAND CLARKE PLACE, RESTON, VA, 20191, US

(21) Appl. No.: 10/333,904

(22) PCT Filed: Dec. 26, 2001
(86) PCT No.: PCT/JP01/11423

(30) Foreign Application Priority Data
Dec. 27, 2000 (JP) 2000397708

(51) Int. Cl. G09G 3/36

(52) U.S. Cl. 345/89

(57) ABSTRACT

In order to provide, when a multi-line selection (MLS) drive method for simultaneously selecting a plurality of scanning electrodes is applied to a liquid crystal display panel, a frame rate control (FRC) gradation display method in which the number of gradations to be displayed is increased without increasing a frame rate and circuit scales, a gradation register for storing a gradation pattern for displaying an ON state and an OFF state at each gradation level, a gradation control circuit for performing a shift arithmetic operation of the gradation pattern and a gradation selecting circuit disposed on each signal electrode are provided so as to cause the gradation control circuit to perform a shift operation of the gradation pattern of the gradation register for each frame synchronously with a vertical synchronous signal, for each line synchronously with a horizontal synchronous signal and for each sub-frame such that the gradation display is performed.

### TECHNICAL FIELD

The present invention relates to a multi-line selection (MLS) drive method in which a plurality of scanning electrodes are simultaneously selected mainly in a simple matrix liquid crystal display panel and mainly has for its object to provide a flickerless gradation display method.

### BACKGROUND ART

In the simple matrix liquid crystal display panel, a liquid crystal material having a high response speed of not more than 100 msec. is desirably employed so as to deal with display of moving pictures. However, if response speed of liquid crystal is raised, a so-called frame response phenomenon occurs and thus, such problems as flicker and drop of contrast arise. In order to solve such problems, a prior art technique called a “multi-line selection (MLS) drive method” in which a plurality of L scanning electrodes are simultaneously selected is known. A summary of a MLS drive method for selecting four scanning electrodes simultaneously, which is abbreviated as “MLS4”, hereinafter, is given as follows.

In MLS drive, an orthogonal function 215 expanded by an orthogonal function generator 213 performs an H×S matrix operation by an input signal 211 and an arithmetic unit 212 and outputs to the result to a segment signal line 214 as shown in FIG. 10. In the case of simultaneous selection of four rows, the orthogonal function 215 expands a four-row and four-column seed function into the number of scanning electrodes, 168 in this example as shown in FIG. 11. Therefore, the number of the columns is the number of the scanning electrodes and has a value of “1” or “−1” at the time of selection of the scanning electrodes and a value of “0” at the time of the nonselection. Drive waveforms of the scanning electrodes at this time are shown in FIG. 12. As shown in FIG. 12, since four scanning electrodes are selected simultaneously, one frame of the 168 scanning electrodes is constituted by first to fourth sub-frames. Supposing that the input signal 211 does not change among the first to fourth sub-frames, the matrix operation of the orthogonal function 215 is performed. Hereinafter, a principle of the MLS drive method is described and on-state and off-state effective voltages are obtained.

The MLS drive method is a liquid crystal panel driving method based on orthogonal transformation. It is supposed here that “N” denotes the number of scanning lines of the panel, “M” denotes the number of signal lines and “L” denotes the number of simultaneously selected scanning electrodes in MLS drive. A drive signal of the scanning lines is expressed by an N×M orthogonal function matrix H={hₖᵢ} having three values of 1, 0 and −1.

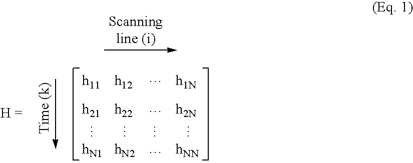

In the above equation 1, column number i denotes No. of each scanning line and row number k denotes time. Meanwhile, hₖᵢ assumes one of the values 1, 0 and −1 in which “1” represents a positive selected voltage of (+aV), “0” represents a nonselected voltage and “−1” represents a negative selected voltage of (−aV). In addition, “V” denotes a reference voltage and “a” denotes a bias ratio. In each row vector, a total of the number of “1” and the number of “−1” coincides with the number L of the simultaneously selected scanning lines.

[h₁₁h₁₂h₁₃h₁₄h₁₅h₁₆ . . . h_{IN}]=[I−11100 . . . 0] (Eq. 2)

For example, assuming that the row vector assumes a value of the above equation 2 at a time point k=1, drive signals of the respective scanning lines at the time point k=1 are given as follows.

Scanning line 1: +aV (Positive selected signal)

Scanning line 2: −aV (Negative selected signal)

Scanning line 3: +aV (Positive selected signal)

Scanning line 4: +aV (Positive selected signal)

Scanning line 5: 0 (Nonselected signal)

Scanning line 6: 0 (Nonselected signal)

- - -

Scanning line N: 0 (Nonselected signal)

The case indicates that the scanning lines 1 to 4 are selected simultaneously but the remaining scanning lines are not selected.

Then, image data indicative of ON state and OFF state of each pixel of the liquid crystal panel is expressed by an N×M image data matrix D={d,j}.

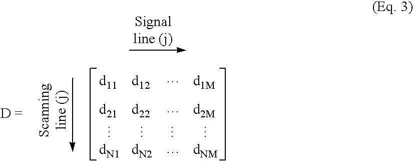

In the above equation (3), row number i denotes No. of each scanning line and column number j denotes No. of each signal line. Meanwhile, dᵢⱼ assumes one of the values 1 and −1 in which “1” represents that the pixel is in OFF state and “−1” represents that the pixel is in ON state.

The drive signal of the signal line is expressed by an N×M signal line driving matrix Y={yₖⱼ} which is a product of the orthogonal function matrix H={hₖᵢ} acting as a scanning line driving matrix and the image data matrix D={dᵢⱼ}. Namely, H×D=Y and thus, the following equation 4 is obtained.

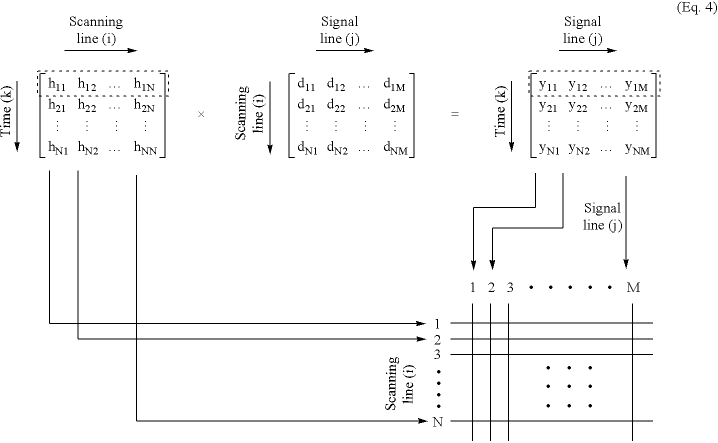

An arithmetic result yₖᵢ of the above equation 4 represents a driving voltage of the signal line No. j at a time k and a value obtained by multiplying the arithmetic result yₖⱼ by a half of the reference voltage V, i.e., (V/2) is applied. Here, in the row vector of the scanning line driving matrix H, the number of 1 or −1 is L and the remainder are 0 wholly. Meanwhile, the column vector of the image pattern matrix D is constituted by only 1 or −1. Therefore, values which yₖⱼ can assume are determined by the number L of the simultaneously selected scanning lines and have (L+1) cases of −L, −L−2), −(L−4), - - - , 0, - - - , L−4, L−2 and L. Therefore, from the number L of the simultaneously selected scanning lines, a signal line driving voltage can assume voltages of −LV/2, −(L−2)V/2, −(L−4)V/2, - - - , 0, - - - , (L−4)V/2, (L−2)V/2 and LV/2. Concrete examples in which L is equal to 2, 4 and 8 are shown below.

| | Arithmetic result (yₖⱼ) | Signal side driving voltage |
|---|---|---|
| L = 2 | 0, ±2 | 0, ±V |
| L = 4 | 0, ±2, ±4 | 0, ±V, ±2 V |
| L = 8 | 0, ±2, ±4, ±6, ±8 | 0, ±V, ±2 V, ±V, ±2 V |

Based on the above information, an effective value Vᵢⱼ of the voltage applied to a pixel (i, j) of a scanning line No. i and a signal line No. j in the liquid crystal panel is obtained. Supposing that (Vcol)ₖᵢ and (Vrow)ₖⱼ denote a scanning line driving voltage and a signal line driving voltage at a time k, respectively, the effective voltage Vᵢⱼ is a time average of a sum of squares of differences therebetween at time points k=1, 2, - - - , N and thus, given as follows.

$${V}_{ij}^{2} = {\sum }_{k = 1}^{N} {[ {( Vcol )}_{ki} - {( Vrow )}_{kj} ]}^{2} / N \qquad ( Eq . 5 )$$

The scanning driving voltage is obtained by multiplying the orthogonal function (hₖᵢ) by the reference voltage V and the bias ratio a and therefore, is given as follows.

(Vcol)ₖᵢ=aV·hₖᵢ (Eq. 6)

Meanwhile, the signal line driving voltage is obtained by multiplying the arithmetic result (yₖⱼ) by a half of the reference voltage V and therefore, is expressed as follows.

$${( Vrow )}_{kj} = \frac{V}{2} {y}_{kj} \qquad ( Eq . 7 )$$

The effective voltage of the equation 5 is changed as follows.

$$\begin{matrix}{V}_{ij}^{2} = {\sum }_{k = 1}^{N} {( aV \cdot {h}_{ki} - \frac{V}{2} {y}_{kj} )}^{2} / N \\ = ( {a}^{2} {\sum }_{k = 1}^{N} {h}_{ki}^{2} - a {\sum }_{k = 1}^{N} {h}_{ki} {y}_{kj} + \frac{1}{4} {\sum }_{k = 1}^{N} {y}_{kj}^{2} ) \frac{{V}^{2}}{N}\end{matrix} \qquad ( Eq . 8 )$$

In the equation 8, since the number of the simultaneously selected scanning lines is L, the row matrix of the orthogonal function matrix H has L terms in which hₖᵢ is 1 or −1 and the remaining terms in which hₖᵢ is 0 wholly. Therefore, the first tem of the right member of the equation 8 is expressed as follows.

$${\sum }_{k = 1}^{N} {h}_{ki}^{2} = L \qquad ( Eq . 9 )$$

Meanwhile, if H×D=Y is subjected to inverse transformation, the second term of the right member of the equation 8 is expressed as follows.

$$\begin{matrix}D = {H}^{- 1} \cdot Y = \frac{1}{L} {}^{t} H \cdot Y \\ ∴ {\sum }_{k = 1}^{N} {h}_{ki} {y}_{kj} = L \cdot {d}_{ij}\end{matrix} \qquad ( Eq . 10 )$$

In the equation 10, the relation of {H⁻¹=(1/L)^{t}H} which is characteristic of the orthogonal function matrix is employed.

Meanwhile, the third term of the right member of the equation 8 is expressed as follows.

$$\begin{matrix}{\sum }_{k = 1}^{N} {y}_{kj}^{2} = {\vert Y \vert}^{2} = {}^{t} Y \cdot Y = {}^{t} ( H \cdot D ) \cdot ( H \cdot D ) \\ = {}^{t} D \cdot {}^{t} H \cdot H \cdot D = {}^{t} D \cdot ( L \cdot U ) \cdot D \\ = L \cdot ( {}^{t} D \cdot D ) = L {\sum }_{j = 1}^{N} {d}_{ij}^{2} \\ = L \cdot N ( ∵ {d}_{ij} = 1 or - 1 )\end{matrix} \qquad ( Eq . 11 )$$

In the equation 11, U denotes a unit matrix. By substituting the equations 9 to 11 for the equation 8, the following equation 12 is obtained.

$$\begin{matrix}{V}_{ij}^{2} = ( {a}^{2} L - {aLd}_{ij} + \frac{LN}{4} ) \frac{{V}^{2}}{N} = \frac{4 {a}^{2} - 4 {ad}_{ij} + N}{N} \frac{L}{4} {V}^{2} \\ ∴ {V}_{ij} = V \sqrt{\frac{4 {a}^{2} - 4 {ad}_{ij} + N}{N}} \frac{L}{4}\end{matrix} \qquad ( Eq . 12 )$$

The equation 12 is a general formula representing the effective voltage applied to the pixel data dᵢⱼ in MLS drive in which the number of the scanning lines is N and the L scanning lines are selected simultaneously. It is seen that the equation 12 is not affected by the seed function hₖⱼ. Furthermore, it is also seen that although the L scanning lines are selected simultaneously, the effective value applied to the pixel data dᵢⱼ is determined by only dᵢⱼ and does not depend on other elements of the column display pattern, i.e., other elements of the column vector of the image data matrix.

From the equation 12, the effective voltages in ON state (dᵢⱼ=−1) and OFF state (dᵢⱼ=1) are, respectively, given as follows.

$$\begin{matrix}{V}_{ON} = V \sqrt{\frac{4 {a}^{2} 4 a + N}{N} \frac{L}{4}} \\ {V}_{OFF} = V \sqrt{\frac{4 {a}^{2} 4 a + N}{N} \frac{L}{4}}\end{matrix} \qquad ( Eq . 13 )$$

Then, gradation display in such MLS drive method is described. As one of gradation display methods, there is a frame rate control (FRC) method in which a plurality of frames are employed and gradation control is effected by performing on-off control of each frame. FIG. 13 shows one example of the FRC method in the case of display of 8 gradations. In the case of 8 gradations, by using ON state and OFF state of 7 frames as shown in FIG. 13, the gradations are displayed by 8 kinds of gradation patterns from 0/7 to 7/7 Since the gradations are displayed by the gradation patterns of the 7 frames, this example is referred to as “7 FRC”.

However, generally, if multiple gradations are displayed by this FRC method, there is a disadvantage that flickers occurs. Hence, in order to restrain the flickers, there is a method in which timings for turning on and off the pixels are made different from each other among the pixels so as to be scattered in time and a ratio of the number of the on-state pixels to that of the off-state pixels is made coincident, in space, with the number of gradations. In order to scatter timing for turning on and off the pixels, there is a method in which a gradation pattern is subjected to a shift arithmetic operation for each frame synchronously with a vertical synchronous signal. This method is referred to as “frame shift”. FIG. 14 shows a frame shift of 1/7 gradation. In the case of 1/7 gradation, a gradation pattern is constituted by one ON state and six OFF states and positions of the ON states of the frames are shifted rightwards so as to be scattered in time as shown in FIG. 14.

In order to scatter ON state and OFF state in space, there is a method in which a gradation pattern is subjected to a shift arithmetic operation for each frame synchronously with a horizontal synchronous signal. This method is referred to as “line shift”. FIG. 15 shows a line shift of 1/7 gradation. In the case of 1/7 gradation, a gradation pattern is constituted by one ON state and six OFF states and positions of the ON states of the lines are shifted rightwards so as to be scattered in space as shown in FIG. 15.

In order to perform gradation display, for example, 1/7 FRC gradation display in the MLS drive method, gradation display of frame shift is performed by using a gradation pattern of FIG. 16A identically in first to fourth sub-frames as shown in FIG. 16B. Meanwhile, in line shift, a gradation pattern is shifted at an interval of four rows in the case of simultaneous selection of four rows as shown in FIG. 17.

In case the number of display gradations increases in gradation display based on FRC, gradations in which a ratio of the number of ON states to that of OFF states decreases occur, so that flickers are likely to happen. In one method, the flickers are lessened by increasing frame rate but power consumption increases. For example, gradation can be displayed by 7 frames in display of 0.256 colors but 15 frames are required for display of 4096 colors. In order to obtain an identical flicker level in the displays, frame rate should be made about twice. On the other hand, in mobile terminals such as a cellular phone, power consumption is limited and is required to be reduced. Meanwhile, in view of demands for smaller screens of display units and cost reduction, a circuit for dealing with flickers should be simple.

### DISCLOSURE OF INVENTION

The present invention has for its object to provide, with a view to eliminating the above described drawbacks of prior art, a FRC gradation display method in which in a multi-line selection (MLS) drive method suitable mainly for display of moving pictures by selecting a plurality of scanning electrodes simultaneously, the number of gradations to be displayed is increased without increasing a frame rate and circuit scales.

In order to accomplish this object of the present invention, a display device of the present invention includes an arrangement in which flickers are lessened by not only changing an on-off pattern for each frame and for each line in a display screen but distributing ON and OFF states at random also for each sub-frame specific to MLS as much as possible.

### BRIEF DESCRIPTION OF DRAWINGS

FIG. 1 is a functional block diagram of a first embodiment of the present invention.

FIG. 2 is a view explanatory of shift of one example (117 gradation pattern of MLS4 drive) of a gradation pattern in the first embodiment of the present invention.

FIGS. 3A and 3B are views explanatory of shift of a 1/7 gradation pattern and a 2/7 gradation pattern of MLS drive in a second embodiment of the present invention, respectively.

FIGS. 4A and 4B are views explanatory of shift in case a shift amount for each frame is a constant value 2 and variable, respectively in a third embodiment of the present invention.

FIGS. 5A and 5B are views explanatory of shift in case a shift amount for each line is a constant value 1 and variable, respectively in the third embodiment of the present invention.

FIG. 6 is a view explanatory of shift in case a shift amount for each sub-frame is variable in the third embodiment of the present invention.

FIG. 7 is a view showing a shift pattern of red, green and blue in a fourth embodiment of the present invention.

FIG. 8 is a view showing a gradation pattern in an eighth embodiment of the present invention.

FIG. 9 is a view showing a display pattern for setting an optimum shift amount for each line in a tenth embodiment of the present invention.

FIG. 10 is a block diagram showing a prior art MLD drive method.

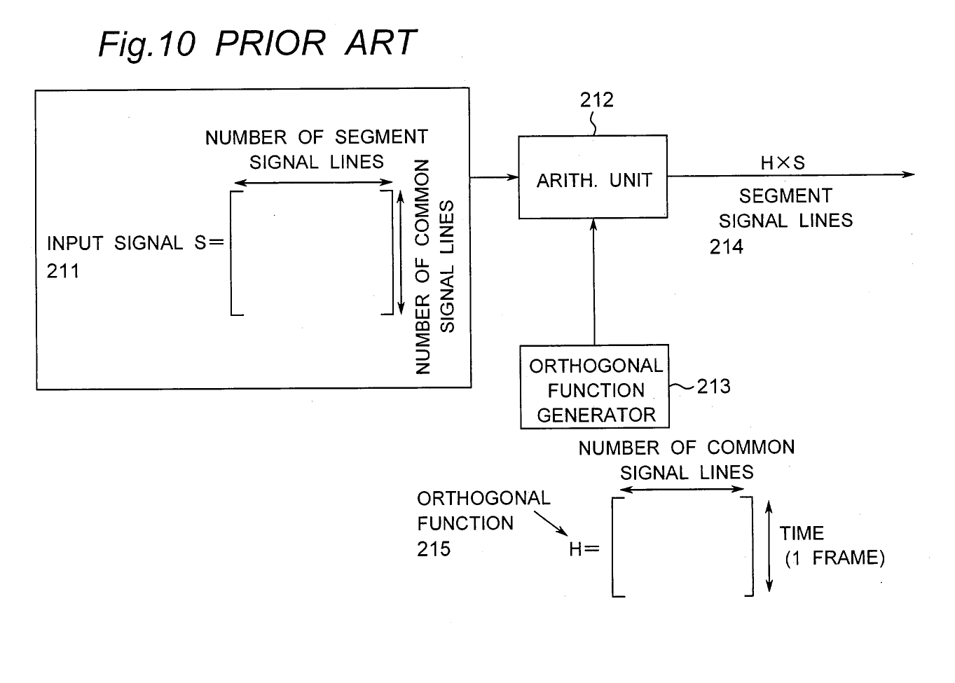

FIG. 11 is a view showing one example of an orthogonal function in the prior art MLS drive method.

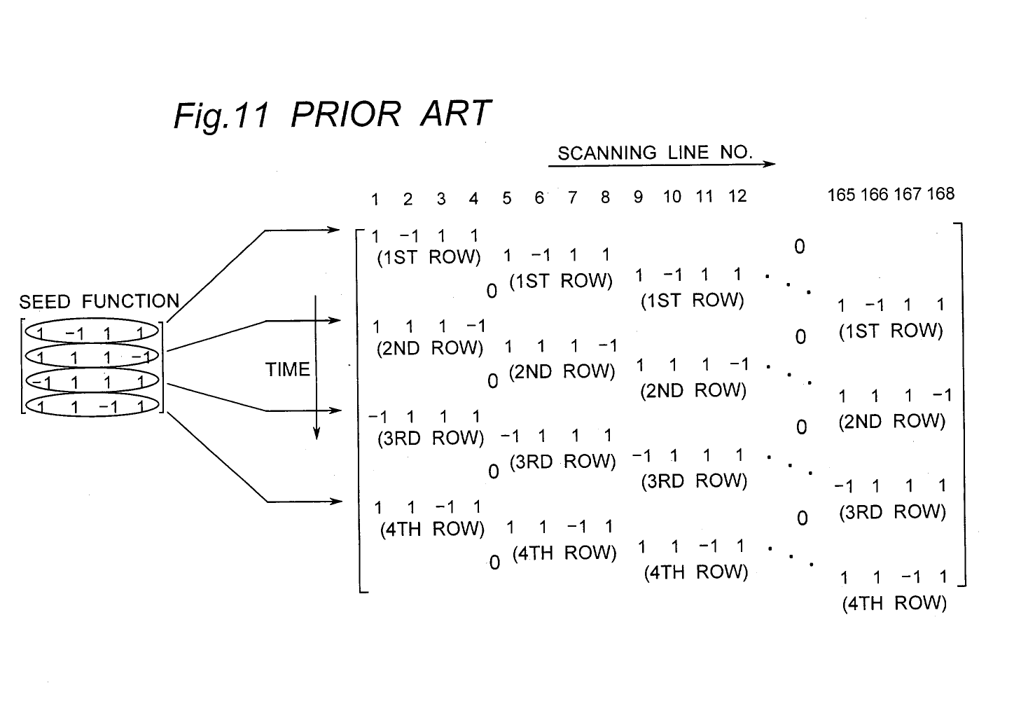

FIG. 12 is a view showing driving waveforms of scanning electrodes in the prior art MLS drive method.

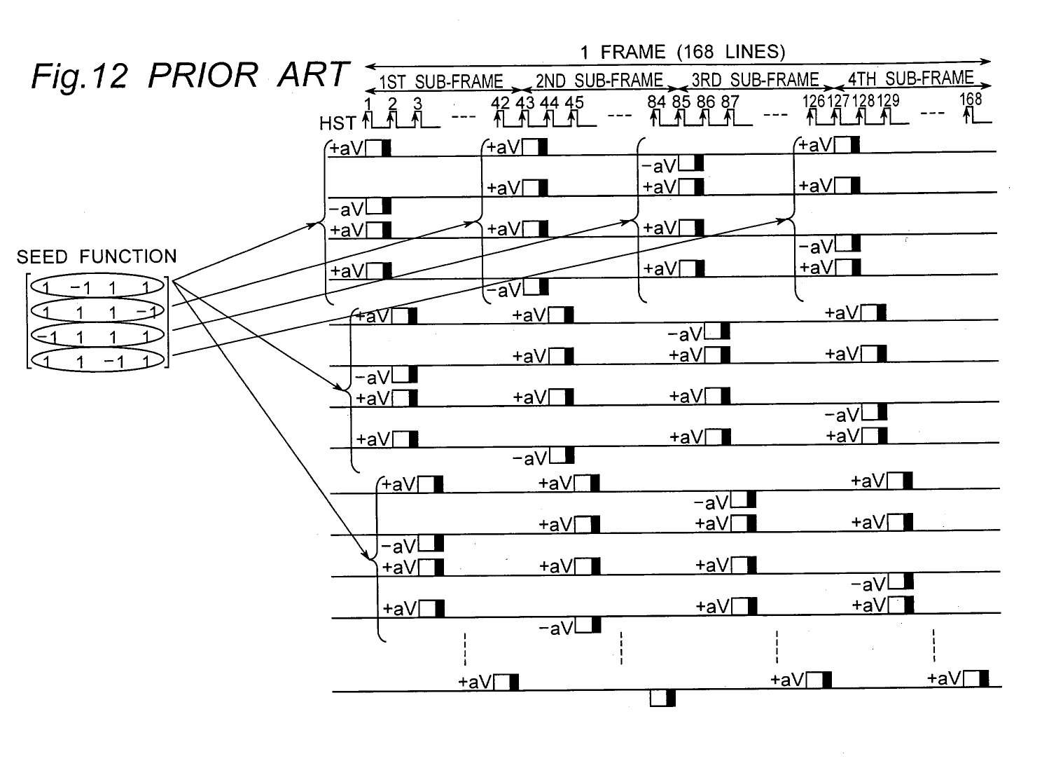

FIG. 13 is a view explanatory of a frame rate control method in display of 8 gradations in the prior art MLS drive method.

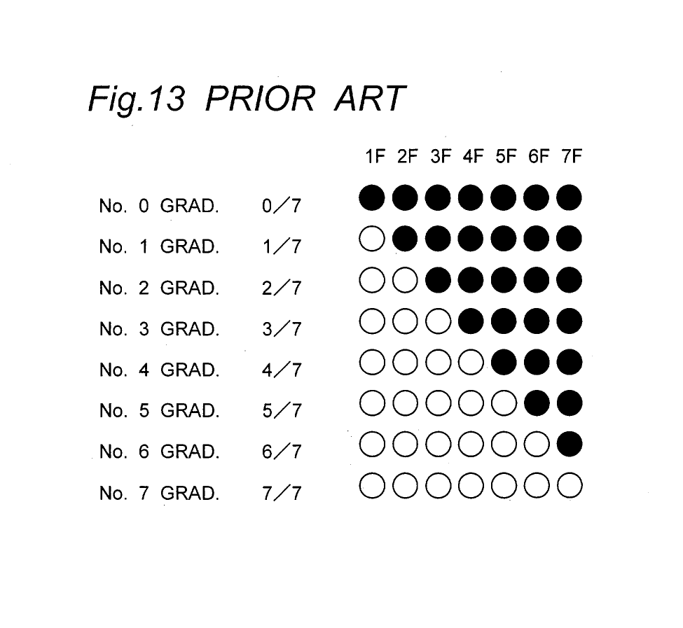

FIG. 14 is a view explanatory of frame shift in the frame rate control method of FIG. 13.

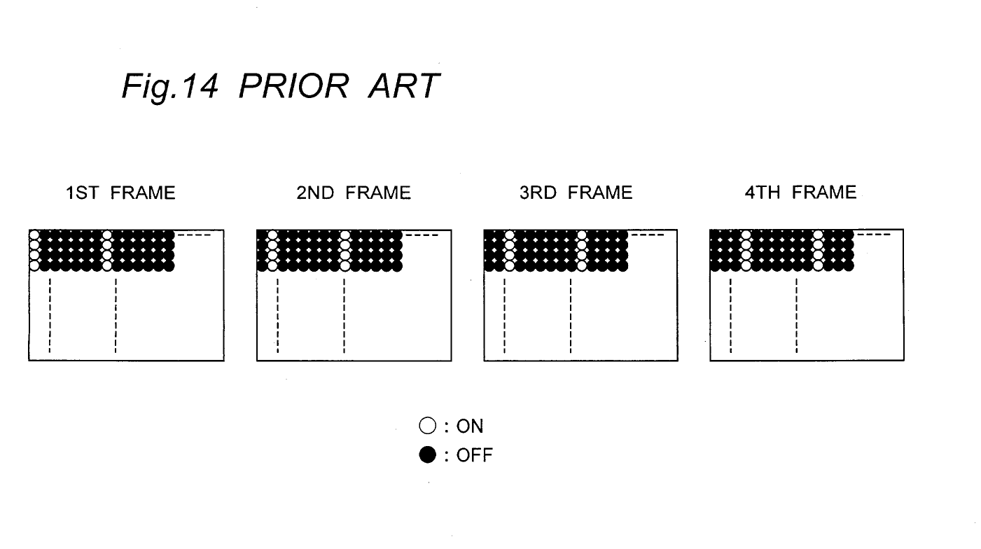

FIG. 15 is a view explanatory of line shift in the frame control method of FIG. 13.

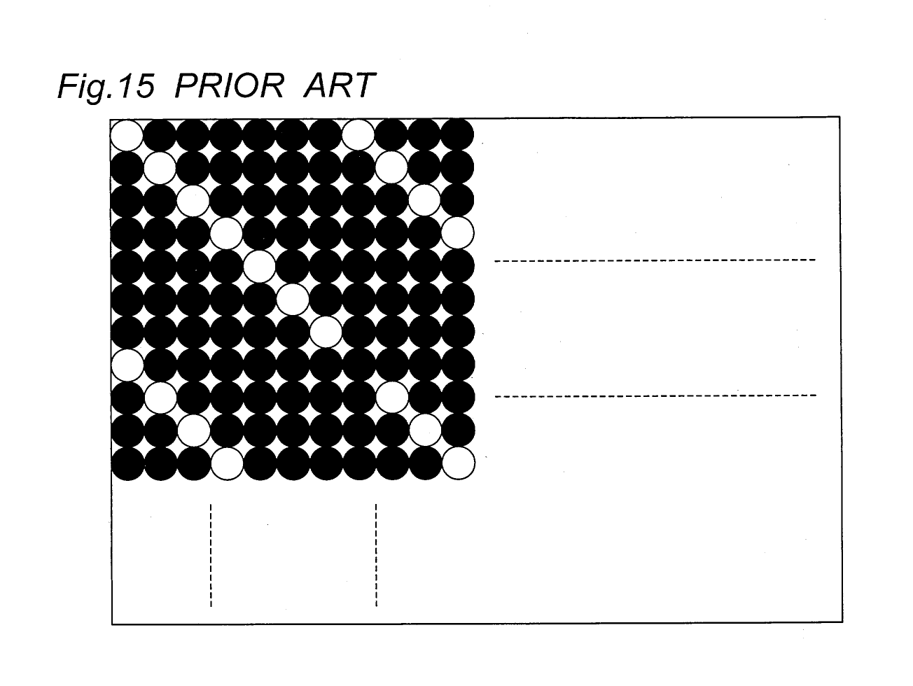

FIG. 16 is a view explanatory of frame shift in the prior art MLS drive method.

FIG. 17 is a view explanatory of line shift in the prior art MLS drive method.

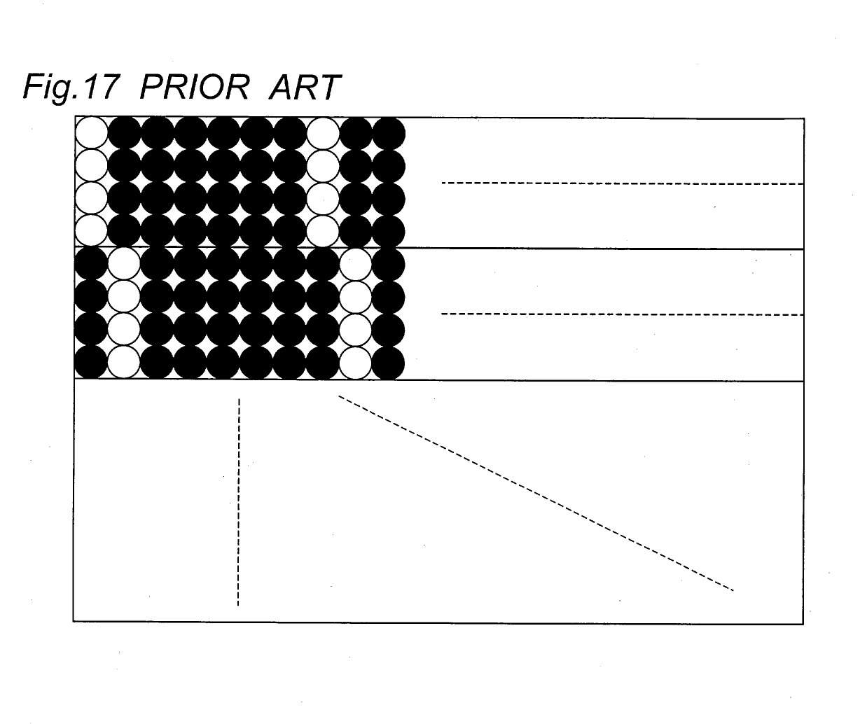

### BEST MODE FOR CARRYING OUT THE INVENTION

Hereinafter, embodiments of the present invention are described with reference to the drawings.

(First Embodiment)

A first embodiment of the present invention relates to a drive method of mainly driving, by a multi-lie selection (MLS) drive method for simultaneously driving a plurality of L scanning lines, a simple matrix liquid crystal display panel in which one frame is constituted by L sub-frames and more particularly, to a drive method in which control is performed by a frame rate control (FRC) method as a gradation display method. A gradation register for storing a gradation pattern for displaying an ON state and an OFF state at each gradation level, a gradation control circuit for performing a shift arithmetic operation of the gradation pattern of the gradation register and a gradation selecting circuit provided on each signal electrode are employed. The present invention is characterized in that by the gradation control circuit, the gradation pattern of the gradation register is subjected to a shift arithmetic operation for each frame synchronously with a vertical synchronous signal, a shift arithmetic operation for each line synchronously with a horizontal synchronous signal and a shift arithmetic operation for each sub-frame such that gradation display is performed.

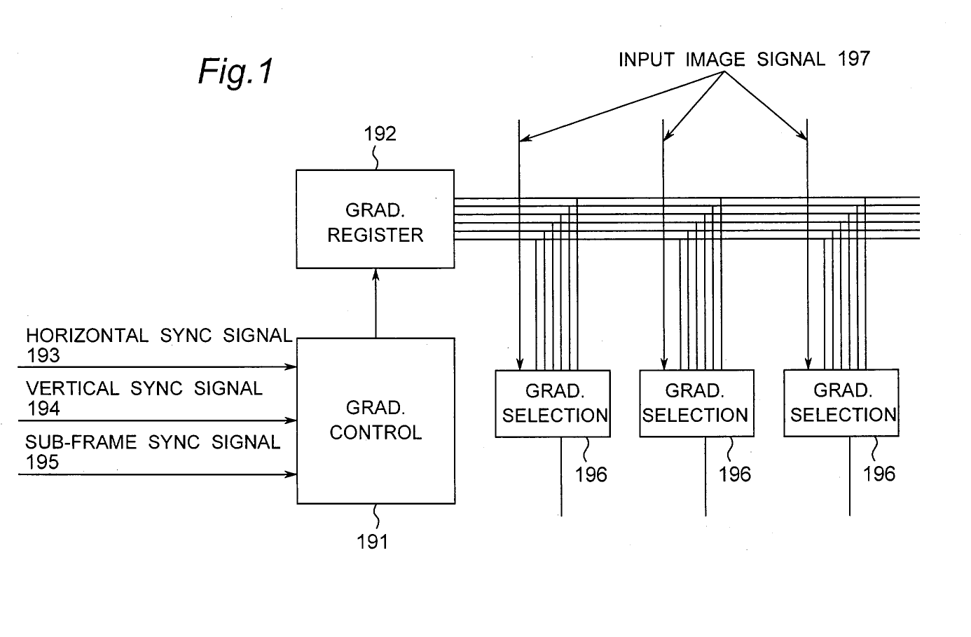

FIG. 1 is a functional block diagram of the present invention. The present invention is constituted by a gradation register circuit 192 for outputting FRC data, a gradation controller 191 for shifting a gradation register for each horizontal synchronous signal 193, each vertical synchronous signal 194 or each sub-frame synchronous signal 195 and a gradation selecting circuit 196 for selecting an output of the gradation register by an input image signal 197.

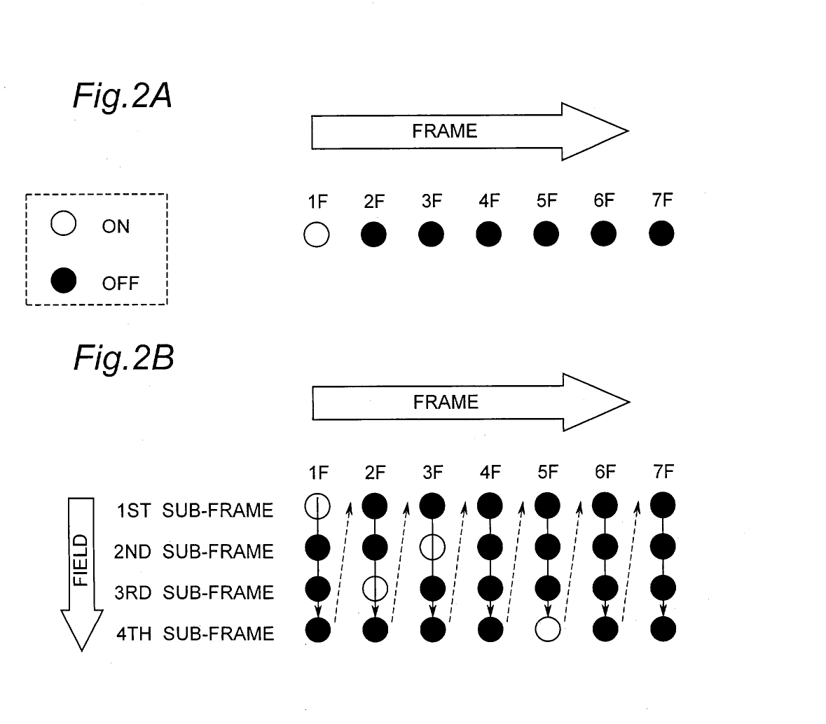

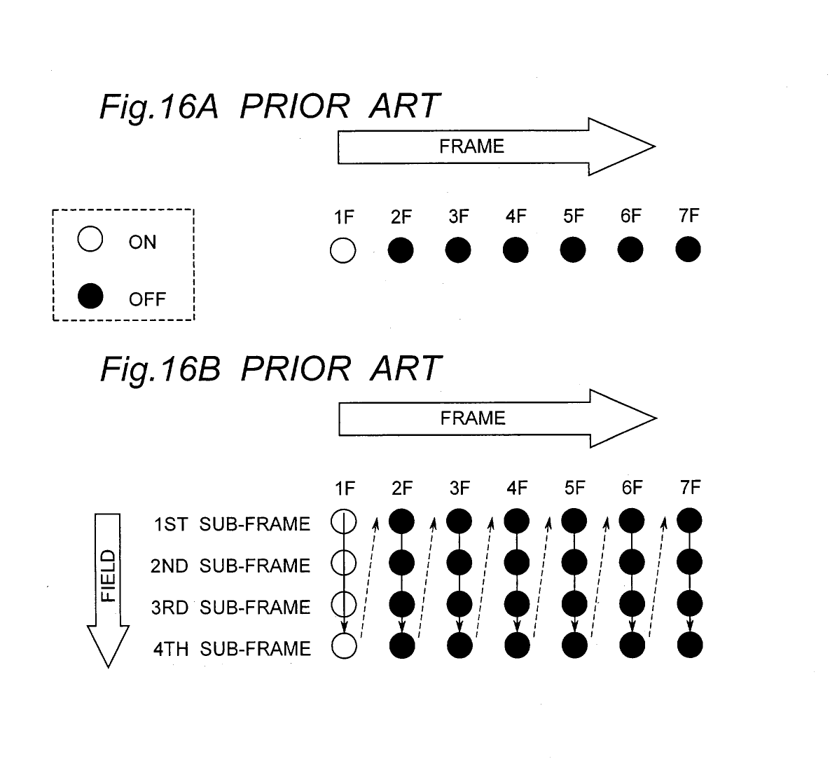

FIG. 2B shows one example of a gradation pattern of the present invention, i.e., 1/7 gradation of MLS drive. In contrast with prior art of FIG. 16B, since the gradation pattern of FIG. 2A is shifted for each sub-frame specific to MLS drive, scatter of the gradation pattern in time becomes large and thus, flickerless gradation display can be performed.

In display of 16 gradations, it has so far been impossible to eliminate flickers by only frame shift and line shift unless a frame frequency is raised to 120 Hz. By performing shift for each sub-frame, flickers can be eliminated at a frame frequency of 100 Hz.

(Second Embodiment)

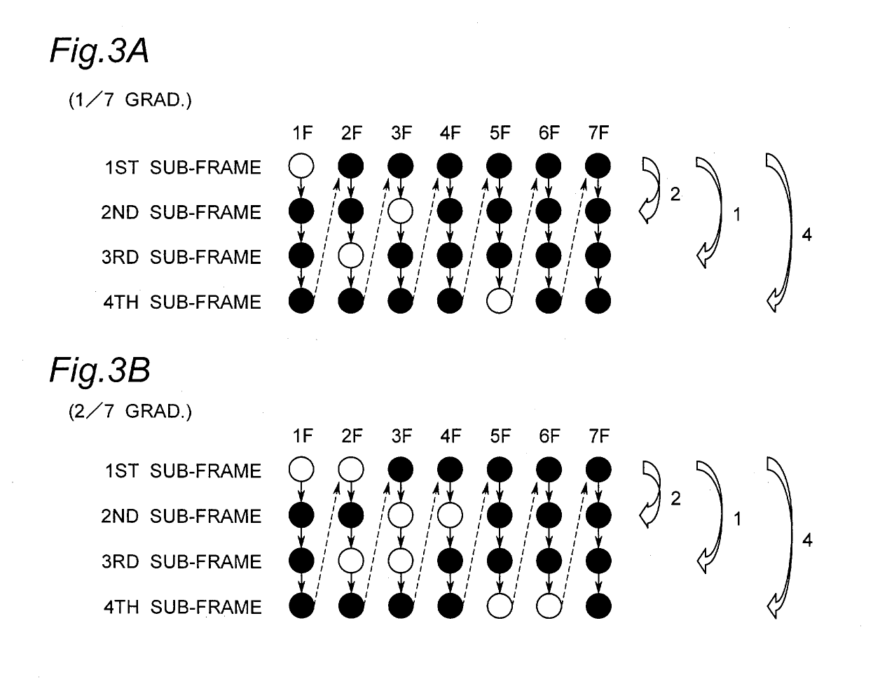

A second embodiment of the present invention is characterized in that in case the number of simultaneously selected scanning lines is L in the first embodiment, (L−1) shift amounts for each sub-frame are set to an identical value at each gradation level. FIG. 3 shows one example of a gradation pattern of the present invention. In FIG. 3, the number of simultaneous selection is four and the gradation patterns of 1/7 gradation and 217 gradation in 0/7 gradation to 7/7 gradation are shown.

In the 1/7 gradation shown in FIG. 3A, if a first sub-frame is regarded as a reference, a shift amount of a second sub-frame is 2, a shift amount of a third sub-frame is 1 and a shift amount of a fourth sub-frame is 4, so that a shift amount for each sub-frame is (2, 1, 4). Likewise, a shift amount for each sub-frame in a gradation pattern of 2/7 gradation shown in FIG. 3B is also (2, 1, 4). Thus, the present invention is characterized in that a shift amount for each sub-frame is set to an identical value in all gradation patterns of 0/7 gradation to 7/7 gradation.

When (L−1) shift amounts for each sub-frame is set to an identical vale at each gradation level in case the number of simultaneously selected scanning lines is L as described above, it has proved that even if the gradation pattern changes among sub-frames, flickers can be restrained without display nonuniformity due to deviation of an effective voltage applied to liquid crystal. For the sake of simplicity, a case of an orthogonal function shown in Table 1 in which the number N of scanning lines is 4 and the number L of simultaneous selection is 4 is considered.

TABLE 1

| | COM1 | COM2 | COM3 | COM4 |
|---|---|---|---|---|
| #1SF | −1 | 1 | 1 | 1 |
| #2SF | 1 | 1 | −1 | 1 |
| #3SF | 1 | −1 | 1 | 1 |
| #4SF | 1 | 1 | 1 | −1 |

It is supposed that gradation data of pixels of scanning lines 1 (COM1) to 4 (COM4) are 1/5 gradation, 1/3 gradation, 7/15 gradation and 14/15 gradation. In this case, a gradation pattern of each scanning line is shown in Table 2.

TABLE 2

| | | FR1 | FR2 | FR3 | FR4 | FR5 | FR6 | FR7 | FR8 | FR9 | FR10 | FR11 | FR12 | FR13 | FR14 | FR15 |
|---|---|---|---|---|---|---|---|---|---|---|---|---|---|---|---|---|
| #1SF | 1/5 | 1 | 0 | 0 | 0 | 0 | 1 | 0 | 0 | 0 | 0 | 1 | 0 | 0 | 0 | 0 |
| #2SF | | 1 | 0 | 0 | 0 | 0 | 1 | 0 | 0 | 0 | 0 | 1 | 0 | 0 | 0 | 0 |
| #3SF | | 1 | 0 | 0 | 0 | 0 | 1 | 0 | 0 | 0 | 0 | 1 | 0 | 0 | 0 | 0 |
| #4SF | | 1 | 0 | 0 | 0 | 0 | 1 | 0 | 0 | 0 | 0 | 1 | 0 | 0 | 0 | 0 |
| #1SF | 1/3 | 1 | 0 | 0 | 1 | 0 | 0 | 1 | 0 | 0 | 1 | 0 | 0 | 1 | 0 | 0 |
| #2SF | | 1 | 0 | 0 | 1 | 0 | 0 | 1 | 0 | 0 | 1 | 0 | 0 | 1 | 0 | 0 |
| #3SF | | 1 | 0 | 0 | 1 | 0 | 0 | 1 | 0 | 0 | 1 | 0 | 0 | 1 | 0 | 0 |
| #4SF | | 1 | 0 | 0 | 1 | 0 | 0 | 1 | 0 | 0 | 1 | 0 | 0 | 1 | 0 | 0 |
| #1SF | 7/15 | 1 | 1 | 1 | 1 | 1 | 1 | 1 | 0 | 0 | 0 | 0 | 0 | 0 | 0 | 0 |
| #2SF | | 1 | 1 | 1 | 1 | 1 | 1 | 1 | 0 | 0 | 0 | 0 | 0 | 0 | 0 | 0 |
| #3SF | | 1 | 1 | 1 | 1 | 1 | 1 | 1 | 0 | 0 | 0 | 0 | 0 | 0 | 0 | 0 |
| #4SF | | 1 | 1 | 1 | 1 | 1 | 1 | 1 | 0 | 0 | 0 | 0 | 0 | 0 | 0 | 0 |
| #1SF | 14/15 | 1 | 1 | 1 | 1 | 1 | 1 | 1 | 1 | 1 | 1 | 1 | 1 | 1 | 1 | 0 |
| #2SF | | 1 | 1 | 1 | 1 | 1 | 1 | 1 | 1 | 1 | 1 | 1 | 1 | 1 | 1 | 0 |
| #3SF | | 1 | 1 | 1 | 1 | 1 | 1 | 1 | 1 | 1 | 1 | 1 | 1 | 1 | 1 | 0 |
| #4SF | | 1 | 1 | 1 | 1 | 1 | 1 | 1 | 1 | 1 | 1 | 1 | 1 | 1 | 1 | 0 |

In Table 2, rows represent sub-frame Nos. and columns represent frame Nos. Meanwhile, a numeral “1” denotes ON state and a numeral “0” denotes OFF state. The gradation pattern of Table 2 indicates a case in which there is no shift among the sub-frames. If average effective voltages of 15 frames of each scanning line are obtained based on a matrix principle of the MLS drive method on the supposition that a bias ratio a is 6 and a reference voltage V is 1, Table 3 is obtained. The reason is described below.

TABLE 3

| COM1 | COM2 | COM3 | COM4 |
|---|---|---|---|
| 33.40 | 35.00 | 36.60 | 42.20 |

Generally, effective voltages of ON state and OFF state are given by an equation 13 as described earlier. If 4, 4, 6 and 1 are, respectively, substituted for conditions N, L, a and V in the equation 13, an on-state effective voltage V_{ON} of 43 and an off-state effective voltage V_{OFF} of 31 are obtained. Since 1/5 gradation has one ON state and four OFF states in five frames, the effective voltage is (43+31×4)/5=33.4. Similarly, an effective voltage of 1/3 gradation is (43+31×2)/3=35.0, an effective voltage of 7/15 gradation is (43×7+31×8)/15=36.6 and an effective value of 14/15 gradation is (43×14+31)/15=42.2. Namely, these values coincide with those of Table 3.

Here, shift among sub-frames is given only in the gradation pattern of 1/5 gradation as shown in Table 4.

TABLE 4

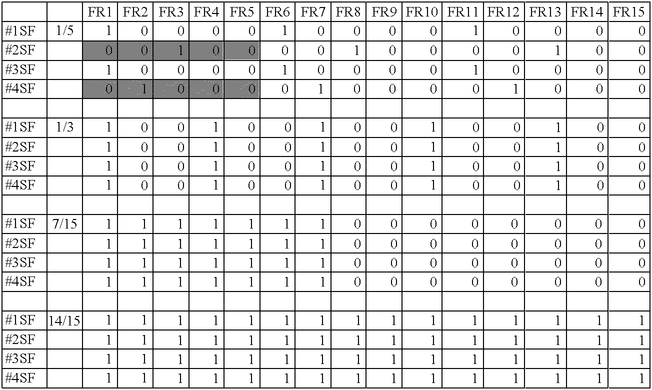

Namely, it is supposed here that the second, third and fourth sub-frames in the gradation pattern are rightwards shifted through 2, 0 and 1 relative to the first sub-frame, respectively. In this case, if an effective voltage of each scanning line is obtained based on the matrix principle of the MLS drive method, Table 5 is obtained and is different from Table 3 in which there is no shift among the sub-frames.

TABLE 5

| COM1 | COM2 | COM3 | COM4 |
|---|---|---|---|
| 33.43 | 35.03 | 36.63 | 42.23 |

Namely, if shift among the sub-frames is introduced, gradation disruption occurs due to deviation of the effective voltage. However, as shown in Table 6, it is supposed that an identical shift among the sub-frames is imparted to not only the gradation pattern of 1/5 gradation but the gradation patterns of 1/3 gradation, 7/15 gradation and 14/15 gradation.

TABLE 6

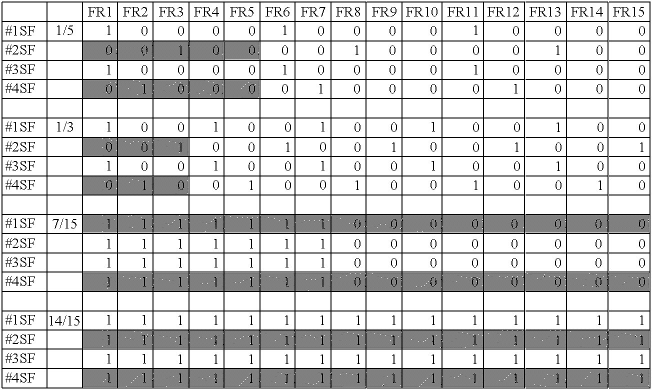

Namely, it is supposed here that the second, third and fourth sub-frames in the gradation patterns of all the gradation levels are rightwards shifted through 2, 0 and 1 relative to the first sub-frame, respectively. In this case, if an effective voltage of each scanning line is obtained based on the matrix principle of the MLS drive method, Table 7 is obtained and coincides with Table 3 in which there is no shift among the sub-frames.

TABLE 7

| COM1 | COM2 | COM3 | COM4 |
|---|---|---|---|
| 33.40 | 35.00 | 36.60 | 42.20 |

Namely, if an identical shift is introduced among sub-frames of the gradation pattern at each gradation level, gradation disruption does not occur without deviation of the effective voltage. Namely, it has proved that flickers can be restrained without display nonuniformity due to deviation of an effective voltage applied to liquid crystal.

(Third Embodiment)

A third embodiment of the present invention is characterized in that in the second embodiment, a shift amount for each frame of the gradation pattern at each gradation level, a shift amount for each line and (L−1) shift amounts for each sub-frame having an identical value at each gradation level are variable.

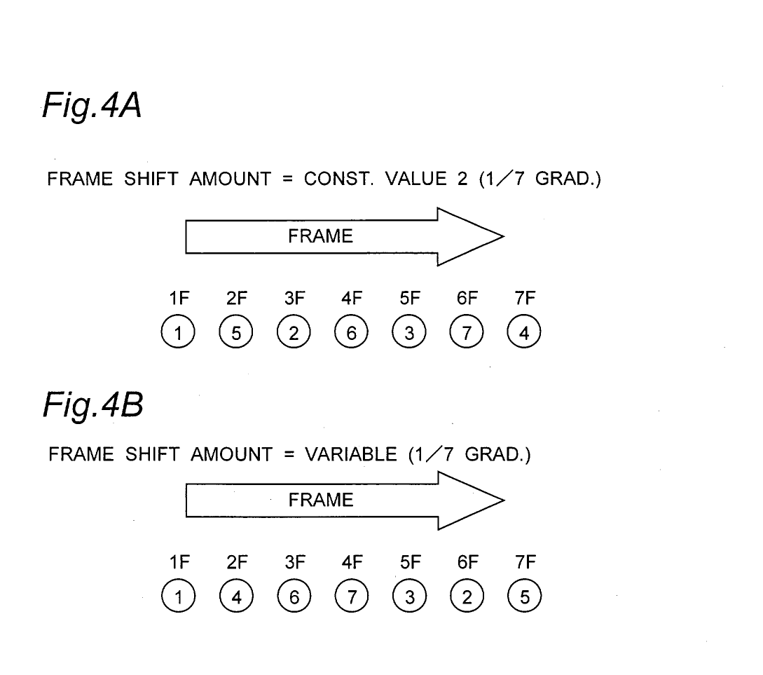

FIGS. 4A and 4B show cases in which a shift amount for each frame is a constant value 2 and variable, respectively. Numerals indicate orders in. which on-state positions are shifted in time. In case the shift amount is the constant value 2 as shown in FIG. 4A, on-state positions are shifted regularly from left to right, so that human eyes perceive that gradation is flowing. On the other hand, in case the shift amount is variable at random as shown in FIG. 4B, on-state positions are shifted at random and thus, gradation flow is restrained.

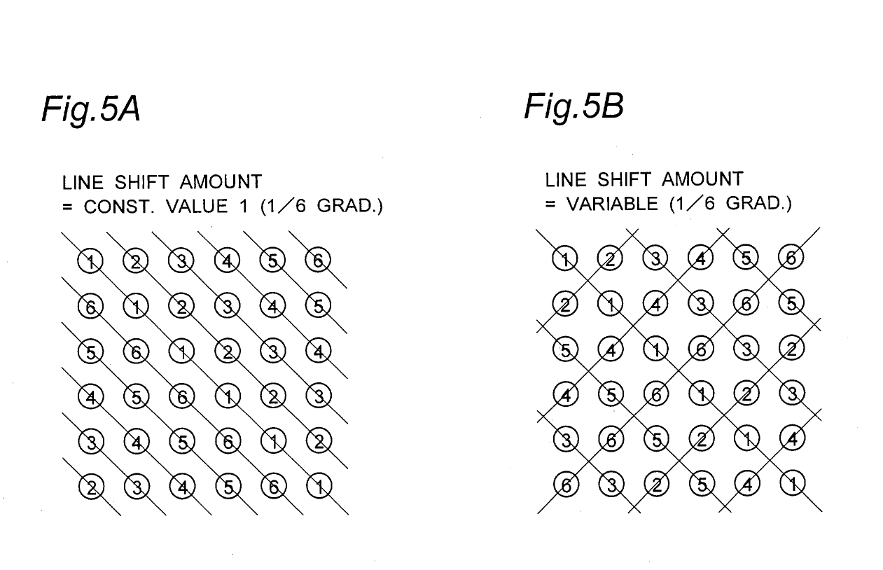

FIGS. 5A and 5B show cases in which a shift amount for each line is a constant value 1 and variable, respectively. Numerals indicates orders in which on-state positions are shifted in time. In case the shift amount is the constant value 1 as shown in FIG. 5A, on-state positions are shifted regularly from left to right, so that human eyes perceive that gradation is flowing. On the other hand, in case the shift amount is variable at random as shown in FIG. 5B, on-state positions are shifted alternately and thus, gradation flow is restrained.

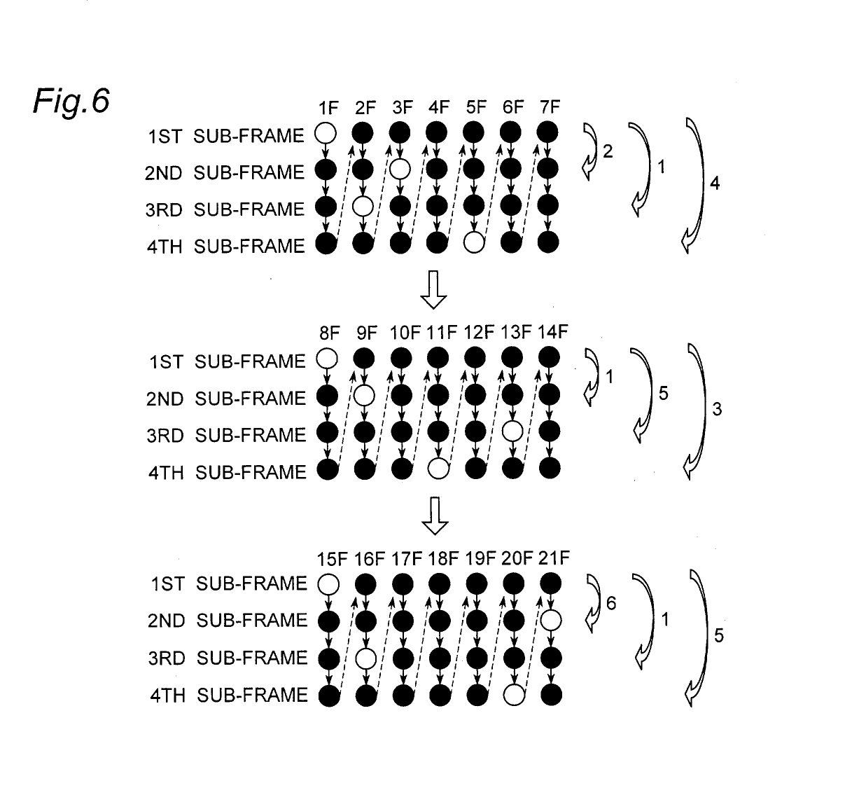

In the present invention, variable function of such shift amount is applied to shift amount for each sub-frame. FIG. 6 shows one example (1/7 gradation) of a gradation pattern in case a shift amount for each sub-frame is variable. In the case of 1/7 gradation, since gradation display is completed by 7 frames, gradation deviation does not occur even if the shift amount for each sub-frame is changed at an interval of 7 frames. Hence, in FIG. 6, since the shift amount for each sub-frame is changed at the interval of 7 frames in the order of (2, 1, 4), (1, 5, 3) and (6, 1, 5), scatter in time is increased and thus, flickers can be restrained.

(Fourth Embodiment)

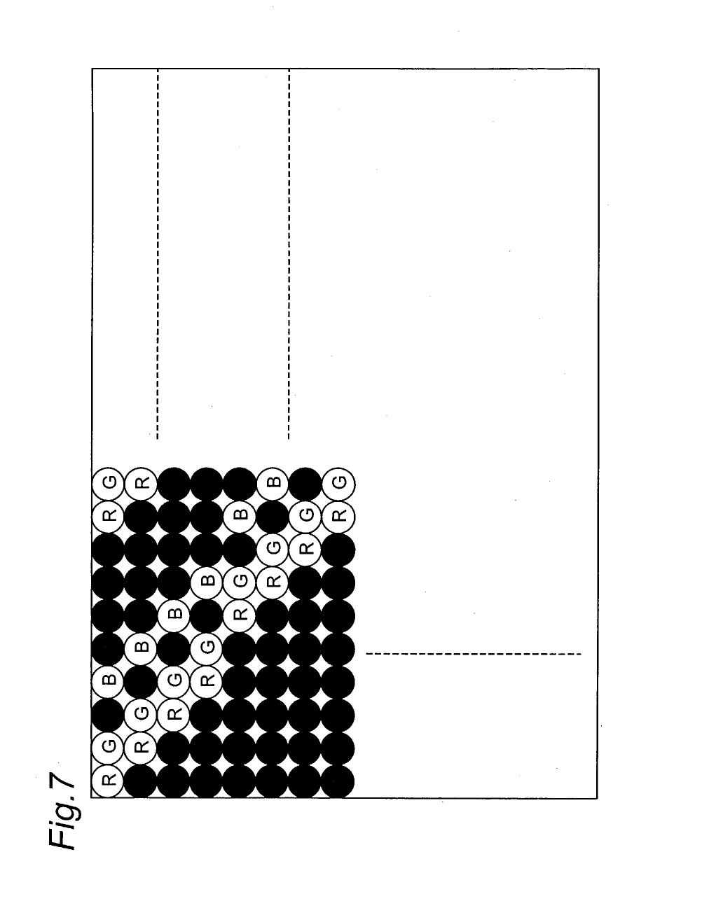

A fourth embodiment of the present invention is characterized in that in the third embodiment, a shift amount for each frame of the gradation pattern at each gradation level in red, green and blue, a shift amount for each line and (L−1) shift amounts for each sub-frame having an identical value at each gradation level are variable. FIG. 7 shows shifts in red, green and blue. As shown in FIG. 7, it is seen that the gradation patterns of green and blue are shifted through 1 and 3 relative to the gradation pattern of red. Thus, by shifting the gradation patterns of red, green and blue even at the identical gradation level, flickers can be restrained.

(Fifth Embodiment)

A fifth embodiment of the present invention is characterized in that in the second embodiment, a shift amount for each frame is set to an identical value at each gradation level and (L−1) shift amounts for each sub-frame having an identical value at each gradation level are set to the shift amount for each frame or 0. For example, in case 8 gradations are displayed by using 7 frames in MLS drive of simultaneous selection of four lines, values of 1, 2, 3, 4, and 6 can be set as the shift amount for each frame at each of the gradation levels from 0/7 to 7/7. However, if a frame shift amount at each gradation level is set to an identical value of, for example, 5 and three shift amounts for each sub-frame are set to 5 or 0, e.g., (5, 0, 5), interference among the gradations is lessened and thus, flickers can be restrained.

(Sixth Embodiment)

A sixth embodiment of the present invention is characterized in that in case a liquid crystal display panel for displaying 16 gradations of 4096 colors is driven in the fifth embodiment, gradation patterns for displaying ON state and OFF state at each gradation level are constituted by a unit of 15 frames from 0/15, 1/15, - - - , 15/15, a shift amount for each frame is set to one of 1, 2, 4, 7, 8, 11, 13 and 14 and (L−1) shift amounts for each sub-frame having an identical value at each gradation level are set to the shift amount for each frame or 0. If the shift amount is set as described above, interference among the gradations is lessened even display of 16 gradations of 4096 colors, so that flickers can be restrained even if a frame frequency is lowered to 80 Hz.

(Seventh Embodiment)

A seventh embodiment of the present invention is characterized in that in case a liquid crystal display panel for displaying 16 gradations of 4096 colors is driven in the fifth embodiment, a least common multiple of the number of frames forming gradation patterns for displaying ON state and OFF state at each gradation level is 24, a shift amount for each frame at each gradation level is set to 5 and (L−1) shift amounts for each sub-frame having an identical value at each gradation level are set to 5 or 0. When 16 gradations are displayed by using frames having the number equal to such divisors of 24 as 2, 3, 4, 6, 8, 12, the number of the frames is smaller than the case of 15 frames, so that occurrence of flickers can be restrained even at a lower frame frequency. A shift amount for each frame, which can be set at each FRC, is as follows.

2FRC: 1 (, 3, 5, - - - )

3FRC: 1, 2 (, 4, 5, - - - )

4FRC: 1, 3(, 5, - - - )

6FRC: 1, 5

8FRC: 1, 3, 5, 7

12FRC: 1, 5, 7, 11

Therefore, the shift amount for each frame, which can be set at each gradation level in common, is either 1 or 5. However, if the shift amount for each frame is 1, gradation flow is apt to happen. Thus, 5 is optimum as the shift amount for each frame. Furthermore, if a shift amount for each sub-frame having an identical value at each gradation level is set to 5 or 0, interference among the gradations is lessened even in display of 16 gradations of 4096 colors, so that flickers can be restrained even if a frame frequency is lowered to 60 Hz.

(Eighth Embodiment)

An eighth embodiment of the present invention is characterized in that in case a liquid crystal display panel for displaying 16 gradations of 4096 colors is driven in the seventh embodiment, gradation patterns for displaying ON state and OFF state at 16 gradation levels are:

Gradation level 0: 0/1

Gradation level 1: 1/12

Gradation level 2: 1/8

Gradation level 3: 1/6

Gradation level 4: 1/4

Gradation level 5: 1/3

Gradation level 6: 3/8

Gradation level 7: 7/12

Gradation level 8: 1/2

Gradation level 9: 5/12

Gradation level 10: 2/3

Gradation level 11: 3/4

Gradation level 12: 5/6

Gradation level 13: 7/8

Gradation level 14: 11/12

Gradation level 15: 1/1

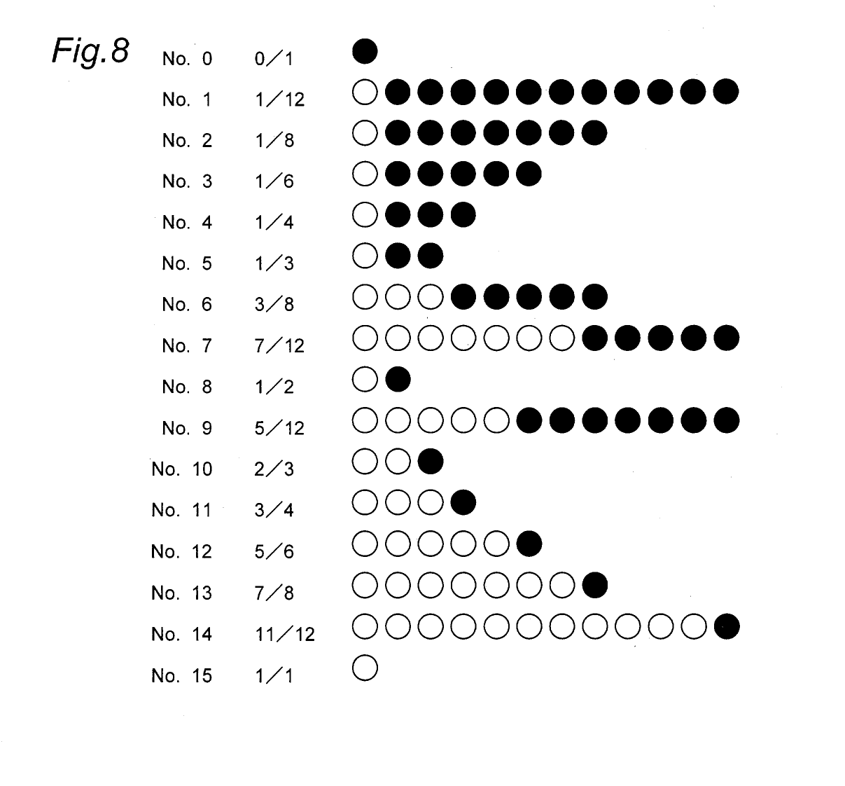

as shown in FIG. 8, a shift amount for each frame having an identical value at each gradation level is set to 5 and (L−1) shift amounts for each sub-frame having an identical value at each gradation level are set to 5 or 0.

By the present invention, interference among the gradations is lessened even in display of 16 gradations of 4096 colors and flickers can be restrained even if a frame frequency is lowered to 60 Hz.

(Ninth Embodiment)

A ninth embodiment of the present invention is characterized in that in case a liquid crystal display panel for displaying 16 gradations of 4096 colors is driven in the eighth embodiment, one frame is constituted by four sub-frames, i.e., first to fourth sub-frames in an MLS4 drive method and combinations of shift amounts from the first sub-frame to the second sub-frame, from the second sub-frame to the third sub-frame and from the third sub-frame to the fourth sub-frame are set to (5, 5, 5), (5, 5, 0), (5, 0, 5), (0, 5, 5.), (5, 0, 0), (0, 5, 0) or (0, 0, 5).

By the present invention, interference among the gradations is lessened even in display of 16 gradations of 4096 colors and flickers can be restrained even if a frame frequency is lowered to 60 Hz.

(Tenth Embodiment)

In a tenth embodiment of the present invention, in case a liquid crystal display panel for displaying 16 gradations of 4096 colors is driven in the ninth embodiment, the liquid crystal display panel is divided into four blocks in a direction of signal lines so as to set an optimum shift amount for each line at the time of display of still images. In the first block, a pattern is displayed in which gradation changes from 0 to 15 at an interval of one dot in a direction of scanning lines. In the second block, a pattern is displayed in which gradation changes from 0 to 15 at an interval of two dots in the direction of the scanning lines. In the third block, a pattern is displayed in which gradation changes from 0 to 15 at an interval of four dots in the direction of the scanning lines. In the fourth block, a pattern is displayed in which gradation changes from 0 to 15 at an interval of eight dots in the direction of the scanning lines. The tenth embodiment of the present invention is characterized in that by stopping, in this state, frame shift at a gradation level for setting the shift amount for each line, the shift amount for each line at each gradation level is set to a value at which vertical stripes due to interference disappear.

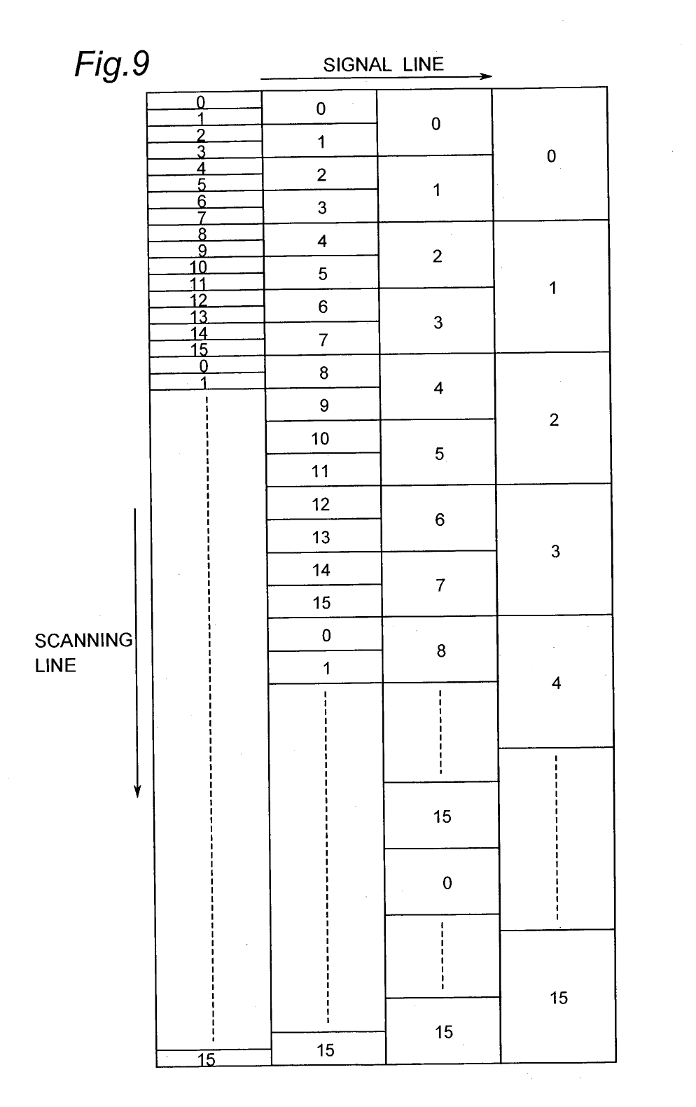

FIG. 9 shows a display pattern for setting the optimum shift amount for each line in the present invention. As shown in FIG. 9, a screen of the display panel is divided into four blocks in the direction of the signal lines. Gradation level changes from 0 to 15 in the direction of scanning lines at an interval of one dot in the first block, at an interval of two dots in the second block, at an interval of four dots in the third block and at an interval of eight dots in the fourth block. When frame shift at the gradation level for setting the optimum shift amount for each line is stopped in this display pattern, vertical stripes should appear in any one of the four blocks if interference with other gradation levels occurs. Therefore, if the shift amount at each gradation level is set for each line such that the vertical stripes due to interference disappear, interference is eliminated even in random patterns of still images such as natural scenes and occurrence of flickers is restrained.

(Eleventh Embodiment)

In an eleventh embodiment of the present invention, in case a liquid crystal display panel for displaying 16 gradations of 4096 colors is driven in the ninth embodiment, the liquid crystal display panel is divided into four blocks in a direction of signal lines so as to set an optimum shift amount for each line at the time of display of moving pictures. In the first block, a pattern is displayed in which gradation changes from 0 to 15 at an interval of one dot in a direction of scanning lines. In the second block, a pattern is displayed in which gradation changes from 0 to 15 at an interval of two dots in the direction of the scanning lines. In the third block, a pattern is displayed in which gradation changes from 0 to 15 at an interval of four dots in the direction of the scanning lines. In the fourth block, a pattern is displayed in which gradation changes from 0 to 15 at an interval of eight dots in the direction of the scanning lines. The eleventh embodiment of the present invention is characterized in that by stopping, in a state where display is shifted in a direction perpendicular to the scanning lines at an interval of frames equal in number to a least common multiple of the numbers of frames each forming the gradation pattern at each gradation level, frame shift at a gradation level for setting a shift amount for each line, the shift amount for each line at each gradation level is set to a value at which vertical stripes due to interference disappear.

In the present invention, by shifting display in the direction perpendicular to the scanning lines at an interval of frames equal in number to a least common multiple of the numbers of the frames each forming the gradation pattern at each gradation level, a pseudo moving picture state is produced in the display pattern of FIG. 9. When frame shift at the gradation level for setting the optimum shift amount for each line is stopped in this display pattern, vertical stripes should appear in any one of the four blocks if interference with other gradation levels occurs. Therefore, if the shift amount at each gradation level is set for each line such that the vertical stripes due to interference disappear, interference is eliminated even in random patterns of moving pictures such as natural scenes and occurrence of flickers is restrained.

(Twelfth Embodiment)

A twelfth embodiment of the present invention is characterized in that a gradation display method based on the frame rate control method of the first embodiment is employed as a method for driving a liquid crystal display device for a personal digital assistant (PDA) and a shift amount for each frame, a shift amount for each line and a shift amount for each sub-frame are set in the method of the tenth embodiment or the eleventh embodiment.

In mobile terminals such as a cellular phone, power consumption is limited and is required to be reduced. Meanwhile, in view of demands for smaller screens of display units and cost reduction, a circuit for dealing with flickers should be simple.

If the driving method based on the gradation display method of the present invention is applied to the liquid crystal display device for the personal digital assistant, occurrence of flickers can be restrained even if a frame frequency is lowered, so that lower power consumption can be materialized. In addition, since the circuit for dealing with flickers is simple, the screens of the display units can be made smaller.

(Thirteenth Embodiment)

A thirteenth embodiment of the present invention is characterized in that a drive circuit at a scanning side and a drive circuit at a signal side are formed into a one-chip MLS driver IC in the twelfth embodiment. The driver IC is mounted by a tape automated bonding (TAB) technique or a chip on glass (COG) technique.

In the MLS driver, since power consumption of driving voltage at the scanning side can be lowered, a driver IC formed integrally with the drive circuit at the signal side is possible. By mounting this MLS driver IC, a liquid crystal display device for a personal digital assistant can be made free at its three sides.

As is clear from the foregoing description, in the drive method of the present invention in which gradation display is performed by a frame rate control (FRC) method through shift operation of the gradation pattern for each sub-frame in multi-line selection (MLS) drive, such remarkable effects for practical use are gained that since occurrence of flickers can be restrained even if a frame frequency is lowered, lower power consumption can be materialized and that since the circuit for dealing with flickers is simple, the screens of the display units can be made smaller.

Meanwhile, MLS 4 drive in which four scanning electrodes are selected simultaneously has been mainly referred to in the foregoing. However, the present invention is not limited to MLS4 but can be applied to any drive method in which not less than two scanning electrodes are selected simultaneously.

Furthermore, the present invention is not limited to a liquid crystal display panel and can be, needless to say, applied also to a simple matrix organic or inorganic electroluminescent (EL) panel.

1. A method of driving, by a multi-line selection (MLS) drive method for simultaneously selecting a plurality of L scanning electrodes, a liquid crystal display panel in which one frame is constituted by L sub-frames, comprising the steps of:
providing a gradation register for storing a gradation pattern for displaying an ON state and an OFF state at each gradation level so as to perform gradation display by a frame rate control (FRC) method, a gradation control circuit for performing a shift operation of the gradation pattern of the gradation register and a gradation selecting circuit disposed on each signal electrode so as to cause the gradation control circuit to perform a shift operation of the gradation pattern of the gradation register for each frame synchronously with a first synchronous signal, for each line synchronously with a second synchronous signal and for each sub-frame such that the gradation display is performed.

2. A method as claimed in claim 1, wherein (L−1) shift amounts for each sub-frame are set to an identical value at each gradation level.

3. A method as claimed in claim 2, wherein a shift amount for each frame of the gradation pattern at each gradation level, a shift amount for each line and the identical (L−1) shift amounts for each sub-frame at each gradation level vary according to the frames.

4. A method as claimed in claim 3, wherein a shift amount for each frame of the gradation pattern at each gradation level of red, green and blue, the shift amount for each line and the identical (L−1) shift amounts for each sub-frame at each gradation level are made variable.

5. A method as claimed in claim 2, wherein a shift amount for each frame is set to a further identical value at each gradation level and the identical value of the (L−1) shift amounts for each sub-frame at each gradation level is set to the further identical value of the shift amount for each frame at each gradation level or zero.

6. A method as claimed in claim 5, wherein the gradation pattern is formed by a unit of 15 frames from 0/15 to 15/15 and a shift amount for each frame is set to one of 1, 2, 4, 7, 8, 11, 13 and 14 at each gradation level;
wherein the identical value of the (L−1) shift amounts for each sub-frame at each gradation level is set to the further identical value of the shift amount for each frame at each gradation level or zero such that 16 gradations of 4096 colors are displayed.

7. A method as claimed in claim 5, wherein a least common multiple of the number of the frames constituting the gradation pattern is 24, the shift amount for each frame at each gradation level is set to 5 and the identical value of the (L−1) shift amounts for each sub-frame at each gradation level is set to 5 or 0 such that 16 gradations of 4096 colors are displayed.

8. A method as claimed in claim 7, wherein the gradation pattern for displaying the ON state and the OFF state of the 16 gradation levels has values of 0, 1/12, 1/8, 1/6, 1/4, 1/3, 3/8, 5/12, 1/2, 7/12, 2/3, 3/4, 5/6, 7/8, 11/12 and 1, the shift amount for each frame at each gradation level is set to 5 and the identical value of the (L−1) shift amounts for each sub-frame at each gradation level is set to 5 or 0 such that 16 gradations of 4096 colors are displayed.

9. A method as claimed in claim 8, wherein one frame is constituted by four sub-frames in a multi-line selection 4 (MLS4) drive method for simultaneously selecting four scanning electrodes and a combination of shift amounts from the first sub-frame to the second sub-frame, from the second sub-frame to the third sub-frame and from the third sub-frame to the fourth sub-frame is set to (5, 5, 5), (5, 5, 0), (5, 0, 5), (0, 5, 5), (5, 0, 0), (0, 5, 0) or (0, 0, 5) such that 16 gradations of 4096 colors are displayed.

10. A method as claimed in claim 9, wherein the liquid crystal display panel is divided into four blocks in a direction of signal lines in order to set an optimum shift amount for each line at the time of display of still images;
wherein by stopping, in a state where a pattern having gradation changing from 0 to 15 at an interval of one dot in a direction of scanning lines is displayed in the first block, a pattern having gradation changing from 0 to 15 at an interval of two dots in the direction of the scanning lines is displayed in the second block, a pattern having gradation changing from 0 to 15 at an interval of four dots in the direction of the scanning lines is displayed in the third block and a pattern having gradation changing from 0 to 15 at an interval of eight dots in the direction of the scanning lines is displayed in the fourth block, frame shift at a gradation level for setting the shift amount for each line, the shift amount f-or each line at each gradation level is set to a value leading to disappearance of vertical stripes due to interference such that 16 gradations of 4096 colors are displayed.

11. A method as claimed in claim 9, wherein the liquid crystal display panel is divided into four blocks in a direction of signal lines in order to set an optimum shift amount for each line at the time of display of moving pictures;
wherein by stopping, in a state where a pattern having gradation changing from 0 to 15 at an interval of one dot in a direction of scanning lines is displayed in the first block, a pattern having gradation changing from 0 to 15 at an interval of two dots in the direction of the scanning lines is displayed in the second block, a pattern having gradation changing from 0 to 15 at an interval of four dots in the direction of the scanning lines is displayed in the third block and a pattern having gradation changing from 0 to 15 at an interval of eight dots in the direction of the scanning lines is displayed in the fourth block and display is shifted in a direction perpendicular to the scanning lines at an interval of frames equal in number to a least common multiple of the numbers of the frames each forming the gradation pattern at each gradation level, frame shift at a gradation level for setting the shift amount for each line, the shift amount for each line at each gradation level is set to a value leading to disappearance of vertical stripes due to interference such that 16 gradations of 4096 colors are displayed.

12. A liquid crystal display device in which a plurality of L scanning electrodes are selected simultaneously and one frame is constituted by L sub-frames, comprising:
a gradation register for storing a gradation pattern for displaying an ON state and an OFF state at each gradation level;
a gradation control circuit for performing a shift operation of the gradation pattern of the gradation register; and
a gradation selecting circuit which is provided on each signal electrode;
wherein the gradation control circuit performs a shift operation. of the gradation pattern of the gradation register for each frame synchronously with a first synchronous signal, for each line synchronously with a second synchronous signal and for each sub-frame.

13. A liquid crystal display device as claimed in claim 12, wherein a first drive circuit for driving the scanning electrodes an a second drive circuit for driving the signal lines are formed into a one-chip driver IC.
